(19) United States
(12) Patent Application Publication
(10) Pub. No.: US 2015/0162107 A1
(43) Pub. Date: Jun. 11, 2015

(54) COLLIMATOR MODULE MANUFACTURING METHOD, COLLIMATOR MODULE, RADIATION DETECTION DEVICE, AND RADIATION IMAGING DEVICE

(71) Applicant: GE MEDICAL SYSTEMS GLOBAL TECHNOLOGY COMPANY, LLC, Waukesha, WI (US)

(72) Inventors: Mai Kato, Tokyo (JP); Katsumasa Nose, Tokyo (JP)

(73) Assignee: GE MEDICAL SYSTEMS GLOBAL TECHNOLOGY COMPANY, LLC, Waukesha, WI (US)

(21) Appl. No.: 14/559,022

(22) Filed: Dec. 3, 2014

(30) Foreign Application Priority Data
Dec. 5, 2013 (JP) 2013252278

(51) Int. Cl. G21K 1/02; B32B 37/18; B32B 38/04; G01N 23/04

(52) U.S. Cl. CPC G21K 1/025; G01N 23/046; B32B 37/18; B32B 38/04; B32B 2038/045

(57) ABSTRACT

A collimator module manufacturing method is provided. The method includes aligning a plurality of collimator plates arranged a predetermined distance apart in one direction, each of the collimator plates being substantially a rectangular solid, bonding a first bar-like member to upper edges of the collimator plates, the first bar-like member being radiolucent and extending from a first collimator plate at a first end to a second collimator plate at a second end in the direction of the collimator plate arrangement, and bonding a second bar-like member to the lower edges of the collimator plates, the second bar-like member being radiolucent and extending from the first collimator plate to the second collimator plate.

### CROSS REFERENCE TO RELATED APPLICATIONS

This application claims the benefit of Japanese Patent Application No. 2013-252278 filed Dec. 5, 2013, which is hereby incorporated by reference in its entirety.

### BACKGROUND

The present invention relates to techniques for improving a collimator module incorporated in a radiation detection device.

There has been proposed a collimator module of which multiple collimator plates are aligned using jigs, with radiolucent sheets of a carbon-fiber-reinforced plastic or the like pasted by adhesive to the upper and lower edges of the collimator plates (see Japanese Unexamined Patent Publication No. 2011-87805).

The proposed collimator module has a simple structure and is relatively easy to manufacture. This collimator module is lightweight and highly accurate in alignment, so that it can be easily installed into the radiation detection device.

The method of manufacturing the above-described type of collimator module involves aligning the multiple collimator plates by use of the jigs. During the process, some spots of the collimator plates are often brought into contact with predetermined reference planes of the jigs so as to enhance the accuracy of the alignment.

The process above causes parts of the jigs to cover some portions of the upper and lower edges of the multiple collimator plates. This makes it impossible to paste a single continuous sheet onto the upper and lower edges. In practice, the sheet is pasted to only those portions of the upper and lower edges of the collimator plates which are not covered by the jigs. Alternatively, after the collimator plates covered with the sheet are removed from the jigs, more sheets are pasted to the remaining portions of the collimator plates.

However, where the sheet is pasted to parts of the upper and lower edges of the multiple collimator plates or where the sheet is divided into pieces before being thus pasted, the stiffness of the assembly is that much reduced. In particular, where the collimator module is used in the radiation detection device of radiation tomographic equipment, a rotating part mounted with the radiation detection device rotates at high speed and may likely deform the collimator module. The resulting effect on module durability and on the stability in the performance of scattered radiation removal is not negligible.

On the other hand, if it is desired to enhance forcefully the stiffness of the collimator module, the manufacturing process tends to become complicated, and the collimator module may likely need to be supplemented with numerous and/or expensive parts. This can incur higher costs and more difficulties in manufacturing the collimator module.

In view of the above circumstances, it has been desired to develop techniques for easily implementing a collimator module that is highly accurate in alignment and offers high stiffness.

### BRIEF DESCRIPTION

In a first aspect, a collimator module manufacturing method is provided. The method includes aligning multiple collimator plates arranged a predetermined distance apart in one direction, each of the collimator plates being substantially a rectangular solid, bonding a first bar-like member to the upper edges of the collimator plates, the first bar-like member being radiolucent and extending from the collimator plate at one end to the collimator plate at the other end in the direction of the collimator plate arrangement, and bonding a second bar-like member to the lower edges of the collimator plates, the second bar-like member being radiolucent and extending from the collimator plate at one end to the collimator plate at the other end in the direction of the collimator plate arrangement.

In this context, the “upper” side is a radiation incident side and the “lower” side is a radiation emitting side.

In a second aspect, in the collimator module manufacturing method above, notches may be formed in each of the upper and lower edges of the collimator plates, and the first and the second bar-like members may each be fitted into the notches.

In this context, the “notches” refer to notched or concave portions.

In a third aspect, the collimator module manufacturing method above may further include before the aligning step, positioning a pair of end blocks a predetermined distance apart in the direction perpendicular to the direction of the collimator plate arrangement, and arranging the collimator plates between the paired end blocks. The bonding steps may include the step of bonding the collimator plates to the paired end blocks.

In a fourth aspect, in the collimator module manufacturing method above, multiple slots extending in the direction of irradiation may be formed on each of the two opposite faces of the paired end blocks, and the arranging step may include the step of inserting each of the collimator plates into each pair of the opposite slots.

In a fifth aspect, the collimator module manufacturing method above may further include after the bonding steps, pasting a radiolucent first single sheet onto those upper edges of the collimator plates to which the first bar-like member has been bonded, the first single sheet being pasted in a manner covering the upper edges, and pasting a radiolucent second single sheet onto those lower edges of the collimator plates to which the second bar-like member has been bonded, the second single sheet being pasted in a manner covering the lower edges.

In a sixth aspect, in the collimator module manufacturing method above, the aligning step may involve aligning the collimator plates by use of a jig. The method may further include, after the bonding steps and before the pasting steps, the step of detaching from the jig the collimator plates to which the first and the second bar-like members have been bonded.

In a seventh aspect, in the collimator module manufacturing method above, the jig may include at least a pair of first comb-like members in which to insert the upper edges of the collimator plates and at least a pair of second comb-like member in which to insert the lower edges of the collimator plates, and the aligning step may include, with one of the paired first comb-like members and one of the paired second comb-like members fixed, the step of sliding the other first comb-like member and the other second comb-like member in the direction of the collimator block arrangement to clamp the collimator plates for alignment.

In an eighth aspect, in the collimator module manufacturing method above, the bonding steps may include the step of bonding the first and the second bar-like members close to the at least one pair of first comb-like members and the at least one pair of second comb-like members.

In a ninth aspect, a collimator module is provided. The collimator modules includes multiple collimator plates arranged a predetermined distance apart in one direction, each of the collimator plates being substantially a rectangular solid, at least one first bar-like member bonded to the upper edges of the collimator plates, the first bar-like member being radiolucent and extending from the collimator plate at one end to the collimator plate at the other end in the direction of the collimator plate arrangement at least one second bar-like member bonded to the lower edges of the collimator plates, the second bar-like member being radiolucent and extending from the collimator plate at one end to the collimator plate at the other end in the direction of the collimator plate arrangement and a pair of end blocks clamping the collimator plates in the direction perpendicular to the direction of the collimator plate arrangement.

In a tenth aspect, in the collimator module above, the first and the second bar-like members may extend in the direction of the collimator plate arrangement.

In an eleventh aspect, in the collimator module above, notches may be formed in each of the upper and the lower edges of the collimator plates; and the first and the second bar-like members may each be fitted into the notches.

In a twelfth aspect, in the collimator module above, multiple slots extending in the direction of irradiation may be formed on each of the two opposite faces of the paired end blocks; and each of the collimator plates may be inserted into each pair of the opposite slots.

In a thirteenth aspect, the collimator module above may further include a radiolucent first single sheet pasted onto those upper edges of the collimator plates to which the first bar-like member has been bonded, the first single sheet being pasted in a manner covering the upper edges, and a radiolucent second single sheet pasted onto those lower edges of the collimator plates to which the second bar-like member has been bonded, the second single sheet being pasted in a manner covering the lower edges.

In a fourteenth aspect, in the collimator module above, the first and the second single sheets may be pasted in a manner covering the slots.

In a fifteenth aspect, in the collimator module above, multiple grooves may be formed on that face of the first single sheet which covers the upper edges of the collimator plates, the upper edges being inserted into the grooves, and multiple grooves may be formed on that face of the second single sheet which covers the lower edges of the collimator plates, the lower edges being inserted into the grooves.

In a sixteenth aspect, in the collimator module above, the first and the second single sheets may each be made from a carbon plastic material.

In a seventeenth aspect, in the collimator module above, the first and the second bar-like members may each be made from a carbon material.

In an eighteenth aspect, a radiation detection device is provided. The radiation detection device includes multiple collimator modules arranged in a predetermined circular or linear direction, each of the collimator modules the above-outlined collimator module, and multiple detector modules arranged in the direction of the collimator module arrangement on a radiation emitting side of the collimator modules.

In a nineteenth aspect, a radiation imaging device including a radiation source and the above-outlined radiation detection device is provided. The radiation source and the radiation detection device are used to image an imaging object.

In a twentieth aspect, in the radiation imaging device above, a tomographic image of the imaging object may be acquired by causing the radiation source and the radiation detection device to rotate around the imaging object and to emit radiation thereto.

According to the above aspects the multiple collimator plates are arranged a predetermined distance apart in the direction of plate thickness and are aligned. The first and the second bar-like members (the upper and lower fixing rods) each extending from the collimator plate at one end to the collimator plate at the other end in direction of the collimator plate arrangement are fixed by adhesive to the upper and the lower edges of the collimator plates, whereby the collimator module is obtained. This makes it possible to maintain the aligned state of the collimator plates without recourse to special steps or parts, thereby implementing easily the collimator module with high alignment precision and high stiffness.

### BRIEF DESCRIPTION OF THE DRAWINGS

Further advantages will become apparent upon a reading of the following description and appended drawings in which:

FIG. 1 is a diagram showing schematically a structure of an X-ray CT scanner;

FIGS. 2A and 2B are diagrams showing typical structures of an X-ray detection device;

FIGS. 3A, 3B, and 3C are diagrams showing a collimator module viewed in the I, CH, and SL directions, respectively;

FIG. 4 is an exploded perspective view of the collimator module;

FIG. 5 is a diagram showing a structure of a manufacturing jig for the collimator module;

FIG. 6 is a diagram showing how end blocks are fixed with a fixing jig;

FIG. 7 is a diagram showing how collimator plates are inserted into slots of the end blocks;

FIG. 8 is a diagram showing how fixing rods are inserted into notches of the collimator plates;

FIG. 9 is a diagram showing how a fixing sheet is pasted to the collimator plates; and

FIG. 10 is a flowchart of the method of manufacturing the collimator module by use of the manufacturing jig.

### DETAILED DESCRIPTION

An exemplary embodiment will now be described below. It should be noted that this embodiment is not limitative of the disclosure.

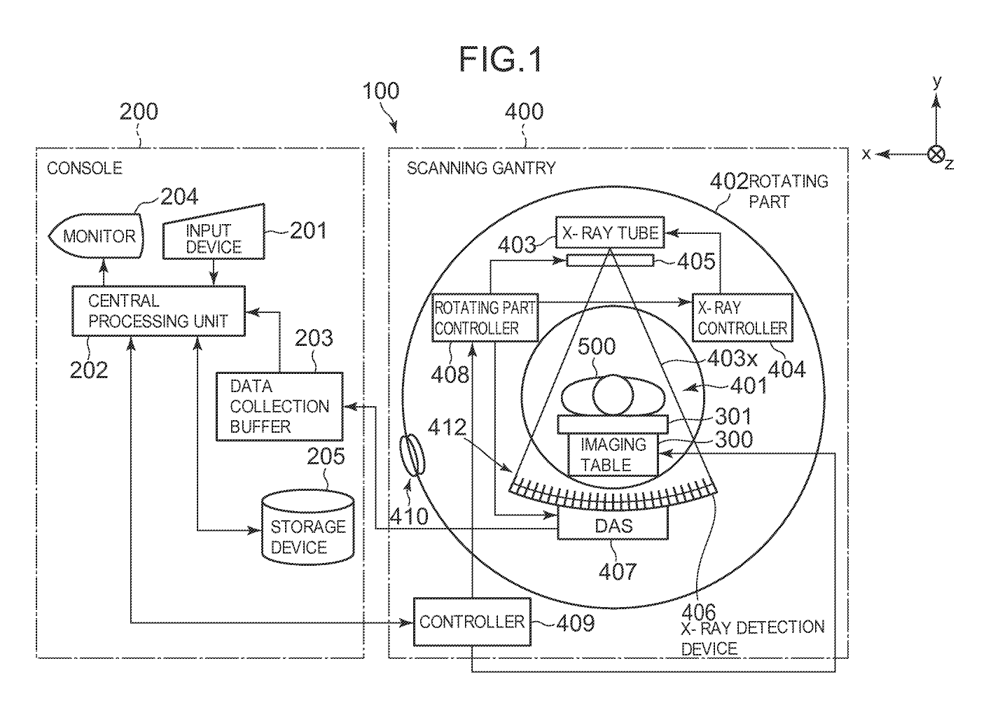

FIG. 1 is a diagram showing schematically a structure of an X-ray CT (Computed Tomography) scanner 100. As shown in FIG. 1, the X-ray CT scanner 100 is equipped with a console 200, an imaging table 300, and a scanning gantry 400.

The console 200 is furnished with an input device 201 that receives input from an operator, a central processing unit 202 that controls the components for acquiring images of an imaging object 500 and processes data for generating the images, a data collection buffer 203 that collects data acquired by the scanning gantry 400, a monitor 204 that displays images, and a storage device 205 that stores programs and data.

The imaging table 300 is provided with a cradle 301 that carries the imaging object 500 and moves it into and out of an opening 401 of the scanning gantry 400. The cradle 301 is linearly moved vertically and horizontally by motors built in the imaging table 500. It is assumed here that the body axis direction of the imaging object 500, i.e., the direction in which the cradle 301 is linearly moved horizontally, is called the z-direction, that the direction in which the cradle 301 is moved vertically is called the y-direction, and that the direction in which the cradle 301 is moved perpendicularly to the z-direction and y-direction is called the x-direction.

The scanning gantry 400 has a circular-shaped rotating part 402 supported rotatably around the opening 401. The rotating part 402 is equipped with an X-ray tube 403, an X-ray controller 404 that controls the X-ray tube 403, an aperture 405 that shapes X-rays 403x generated from the X-ray tube 403 into a fan beam or a cone beam, an X-ray detection device 406 that detects the X-rays 403x having passed through the imaging object 500, a data acquisition system (DAS) 407 that converts the output from the X-ray detection device 406 into X-ray projection data and acquires the data, and a rotating part controller 408 that controls the X-ray controller 404, aperture 405, X-ray detection device 406, and data acquisition system 407. The scanning gantry 400 is furnished with a controller 409 that communicates control signals or the like with the console 200 and imaging table 300. The rotating part 402 is coupled electrically to its supporting members via slip rings 410.

The X-ray tube 403 and X-ray detection device 406 are positioned opposite to each other across an imaging space in which the imaging object 500 is placed, i.e., across the opening 401 of the scanning gantry 400. When the rotating part 402 is rotated, the X-ray tube 403 and X-ray detection device 406 rotate around the imaging object 500 while maintaining the positional relation therebetween. The X-rays 403x radiated from the X-ray tube 403 and shaped by the aperture 405 into the fan beam or cone beam pass through the imaging object 500 before irradiating a detector plane of the X-ray detection device 406. The direction in which the X-rays 403x of the fan beam or cone beam spread over the x-y plane is called the channel direction (CH direction); the direction in which the X-rays 403x spread in the z-direction or the z-direction itself is called the slice direction (SL direction); and the direction in which the X-rays are radiated from the X-ray tube 403 is called the X-ray irradiation direction (I direction).

The structure of the X-ray detection device 406 is explained below.

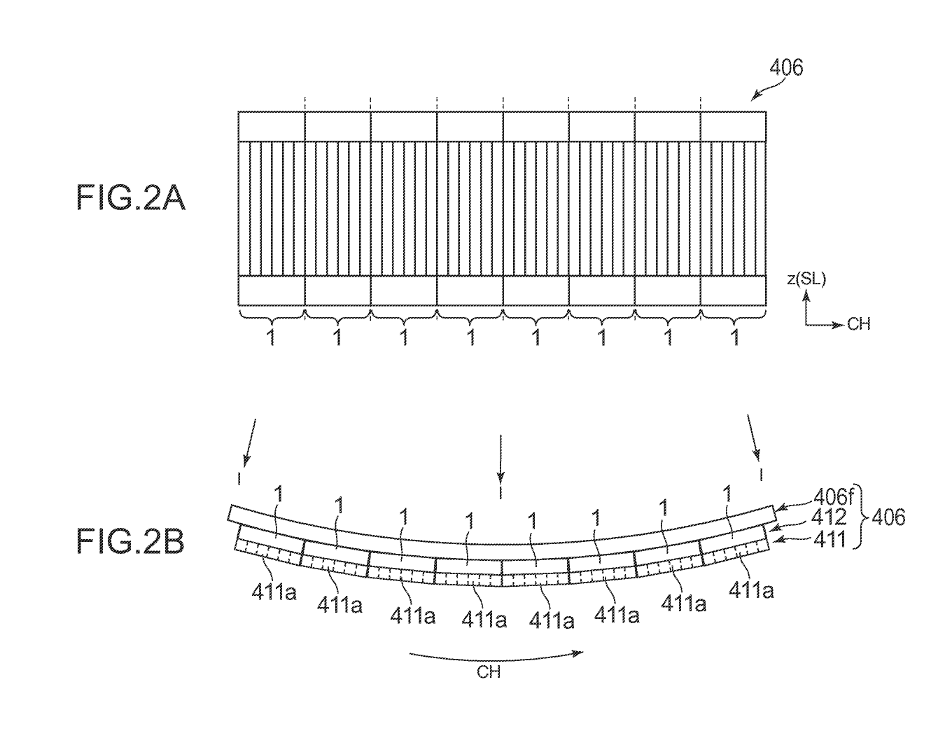

FIGS. 2A and 2B are diagrams showing a typical structure of the X-ray detection device 406. FIG. 2A is a front view showing the X-ray detection device 406 viewed in the I direction, and FIG. 2B is a side view showing the X-ray detection device 406 viewed in the SL direction.

As shown in FIGS. 2A and 2B, the X-ray detection device 406 is equipped with a frame 406f, an X-ray detector 411 attached to the frame 406f, and a collimator device 412.

The X-ray detector 411 has multiple detector modules 411a arranged in the CH direction. Each detector module 411a has multiple detecting elements arranged in matrix in the CH and SL directions. The multiple detecting elements make up an approximately rectangular detector plane.

The collimator device 412 is located on the X-ray incident side of the X-ray detector 411. The collimator device 412 has multiple collimator modules 1 arranged in the CH direction.

The structures of the collimator module 1 are explained below.

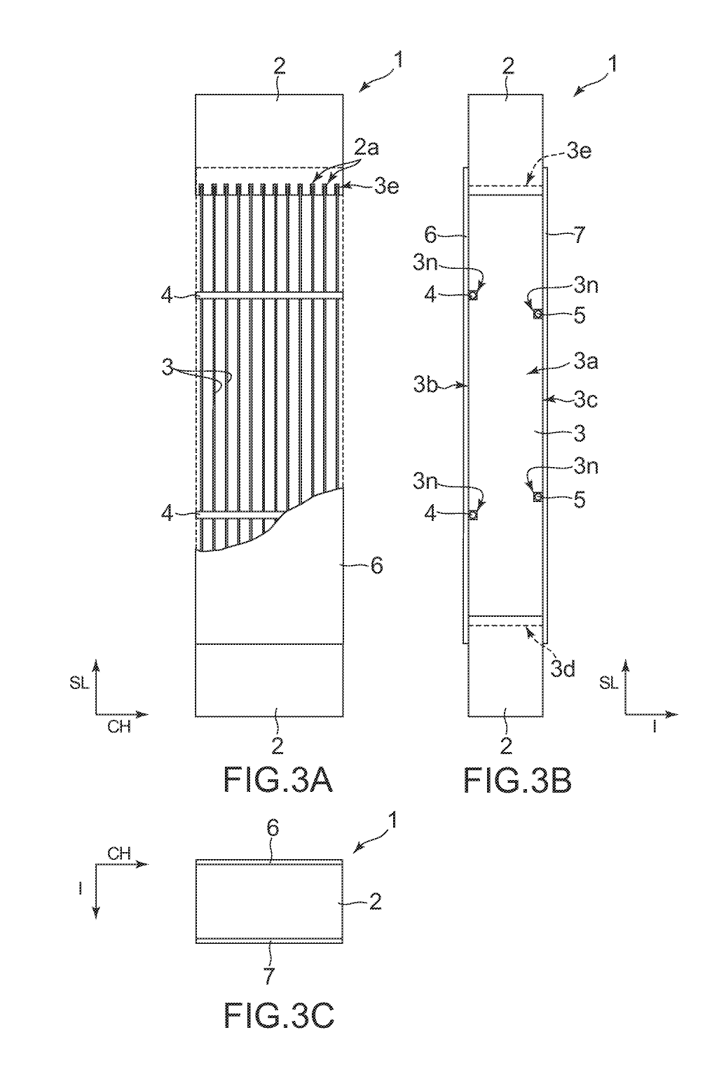

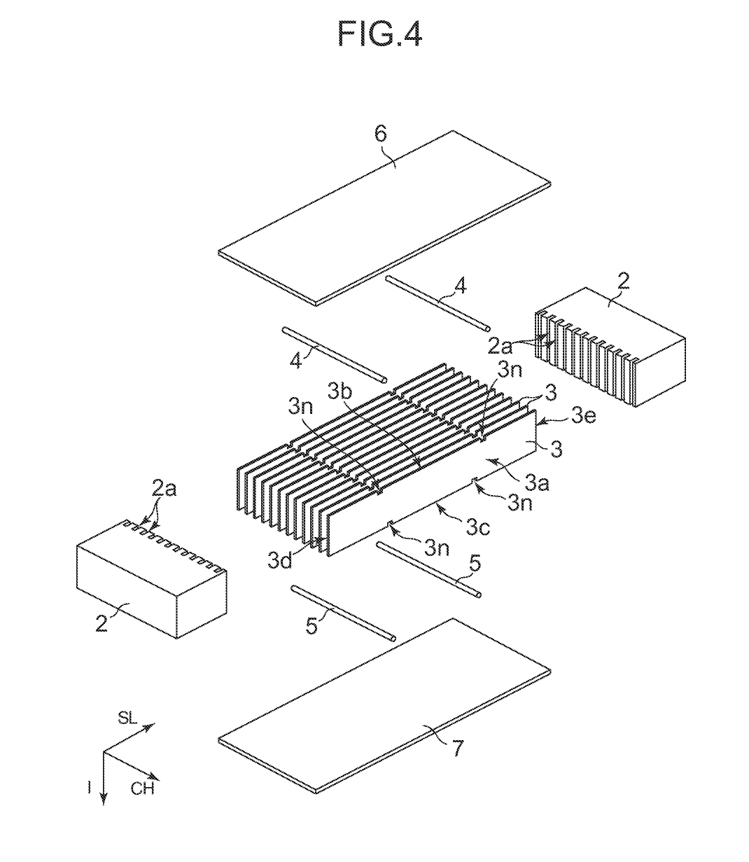

FIG. 3A through FIG. 4 are diagrams showing typical structures of the collimator module 1. FIGS. 3A, 3B, and 3C are diagrams showing the collimator module 1 viewed in the I, CH, and SL directions, respectively. FIG. 4 is an exploded perspective view of the collimator module 1. These diagrams indicate only the major parts of the respective structures. It should also be noted that the diagrams exaggerate the features of the structures for purpose of illustration and that the illustrated structures, dimensions, and numbers of parts are different from those actually provided.

The collimator module 1 has a pair of (i.e., two) end blocks 2, multiple collimator plates 3, two upper fixing rods 4, two lower fixing rods 5, one upper fixing sheet 6, and one lower fixing sheet 7. Incidentally, the upper fixing rods 4 are an example of a first rod-like member, the upper fixing sheet 6 is an example of a first single sheet, and the lower fixing sheet 7 is an example of a second single sheet.

The paired end blocks 2 are made from a material that is stiff, lightweight, and easy to process such as an aluminum alloy. The paired end blocks 2 are positioned apart in the SL direction by a distance slightly shorter than the width of the collimator plates 3 in the SL direction. The paired end blocks 2 are shaped in approximately symmetrical fashion in the SL direction. The paired end blocks 2 are each an approximately rectangular member having a width in each of the CH, SL, and I directions. The two opposed faces of the paired end blocks 2 each have multiple slots 2a formed thereon a predetermined distance apart in the CH direction, each of the slots 2a having a width in the CH direction and extending in the I direction. Locating pins (not shown) are provided on the upper surfaces of the end blocks 2. The locating pins are designed to be inserted into holes (not shown) formed in a frame 406 of the X-ray detection device 406 so that the collimator modules 1 may be positioned onto the frames 406f. For example, 32 slots 2a are formed in one end block 2. The width of each slot 2a in the CH direction, which is wider than the thickness of each collimator plate 3, is 0.4 mm for example. The depth of each slot 2a in the SL direction is 1.0 mm for example. The distance between two adjacent slots 2a is approximately the same as the distance between two adjacent detecting elements and is 1.0 mm, for example.

The multiple collimator plates 3 are each made from the same material and have the same shape except for the margin of error from manufacturing and machining. The collimator plates 3 are made from a material having X-ray shielding capability, i.e. an enhanced ability to absorb X-rays, such as tungsten or molybdenum. The collimator plates 3 have an approximately or substantially rectangular plate-like shape each. Each of the multiple collimator plates 3 has the short side of its plate face 3a (i.e., left-side edge 3d and right-side edge 3e) arranged in parallel with the I direction and the long side of its plate face 3a (i.e., upper edge b and lower edge c) arranged parallel to the SL direction. The upper edges 3b and lower edges 3c of the collimator plates 3 have two notches 3n formed therein each. The two notches 3n in the upper edges 3b are positioned approximately symmetrical to each other about the center of the upper edges 3b in the SL direction. Likewise, the two notches 3n in the lower edges 3c are positioned approximately symmetrical to each other about the center of the lower edges 3c in the SL direction. Incidentally, the notches 3n in the upper edges 3b are located close to upper reference parts 33 and upper pressing parts 34 of an upper alignment jig 30, to be discussed later. The notices 3n in the lower edges 3c are positioned close to lower reference parts 43 and lower pressing parts 44 of a lower alignment jig 40, to be described later. The notches 3n may be circular in shape for example. Alternatively, the notches 3n may be square (U-shaped, with a flat bottom) or cuneiform (V-shaped) in shape. The multiple collimator plates 3 are arranged an approximately constant distance apart in the CH direction in such a manner that the left-side edge 3d and right-side edge 3e in the SL direction of each collimator plate 3 are inserted to each pair of opposite slots 2a. For example, 32 collimator plates 3 are provided. The collimator plates 3 have a thickness of 0.2 mm each, for example. The width of each notch 3n is 0.35 mm for example. The distance between two adjacent collimator plates 3 is approximately the same as the distance between two adjacent detecting elements and is 1.0 mm, for example.

The upper fixing rods 4 and lower fixing rods 5 are made from a material that is translucent to X-rays and has relatively high stiffness, such as carbon. The upper fixing rods 4 and lower fixing rods 5 are each bar-shaped and extend in the CH direction. The upper fixing rods 4 and lower fixing rods 5 have a circular axial plane each, for example. Alternatively, the axial plane of the rods may be square, polygonal, or ellipsoidal in shape. The upper fixing rods 4 are fitted into the notches 3n formed in the upper edges 3b of the multiple collimator plates 3 and are fixed by adhesive to the collimator plates 3. Likewise, the lower fixing rods 5 are fitted into the notches 3n formed in the lower edges 3c of the multiple collimator plates 3 and are fixed by adhesive to the collimator plates 3. The length of the upper fixing rods 4 and lower fixing rods 5 in the CH direction is approximately the same as the width of the end blocks 2 in the CH direction. The axial plane of the upper fixing rods 4 and lower fixing rods 5 has a width slightly smaller than that of the notch 3n, the axial plane width being 0.3 mm, for example.

The upper fixing sheet 6 and lower fixing sheet 7 are made from a material that is translucent to X-rays and has relatively high stiffness, such as carbon plastic (e.g., carbon-fiber-reinforced plastic or CFRP). The upper fixing sheet 6 and lower fixing sheet 7 are each approximately or substantially rectangular in shape. The upper fixing sheet 6 and lower fixing sheet 7 each have a sheet-like shape that is wide in the CH and SL directions. The upper fixing sheet 6 and lower fixing sheet 7 are each wide enough in the SL direction to cover the collimator plates 3 and paired slots 2a in the SL direction, with the collimator plates 3 inserted into the slots 2a. The upper fixing sheet 6 has a lower sheet face 6a that covers the upper edges 3b of the multiple collimator plates 3. The lower sheet face 6a has multiple grooves 6b formed thereon a predetermined distance apart in the CH direction, each groove 6b having a width in the CH direction and extending in the SL direction, so that the upper edges 3b of the collimator plates 3 may be inserted into the grooves 6b. Likewise, the lower fixing sheet 7 has a lower sheet face 7a that covers the lower edges 3c of the multiple collimator plates 3. The upper sheet face 7a has multiple grooves 7b formed thereon a predetermined distance apart in the CH direction, each groove 7b having a width in the CH direction and extending in the SL direction, so that the lower edges 3c of the collimator plates 3 may be inserted into the grooves 7b. For example, 32 grooves are formed on one fixing sheet. The width in the CH direction of each of the grooves 6b and 7b is slightly larger than the thickness of each collimator plate 3 and is 0.3 mm, for example. The depth in the I direction of the grooves 6b and 7b is 0.5 mm for example. The distance between two adjacent grooves 6a as well as between two adjacent grooves 7b is approximately the same as the distance between two adjacent detecting elements and is 1.0 mm, for example. The upper fixing sheet 6 is fixed by adhesive to the multiple collimator plates 3 and to the paired end blocks 2, with the upper edges 3b of the collimator plates 3 inserted into the grooves 6b. Likewise, the lower fixing sheet 7 is fixed by adhesive to the multiple collimator plates 3 and to the paired end blocks 2, with the lower edges 3c of the collimator plates 3 inserted into the grooves 7b.

The structure of a manufacturing jig 10 for the collimator module is now explained.

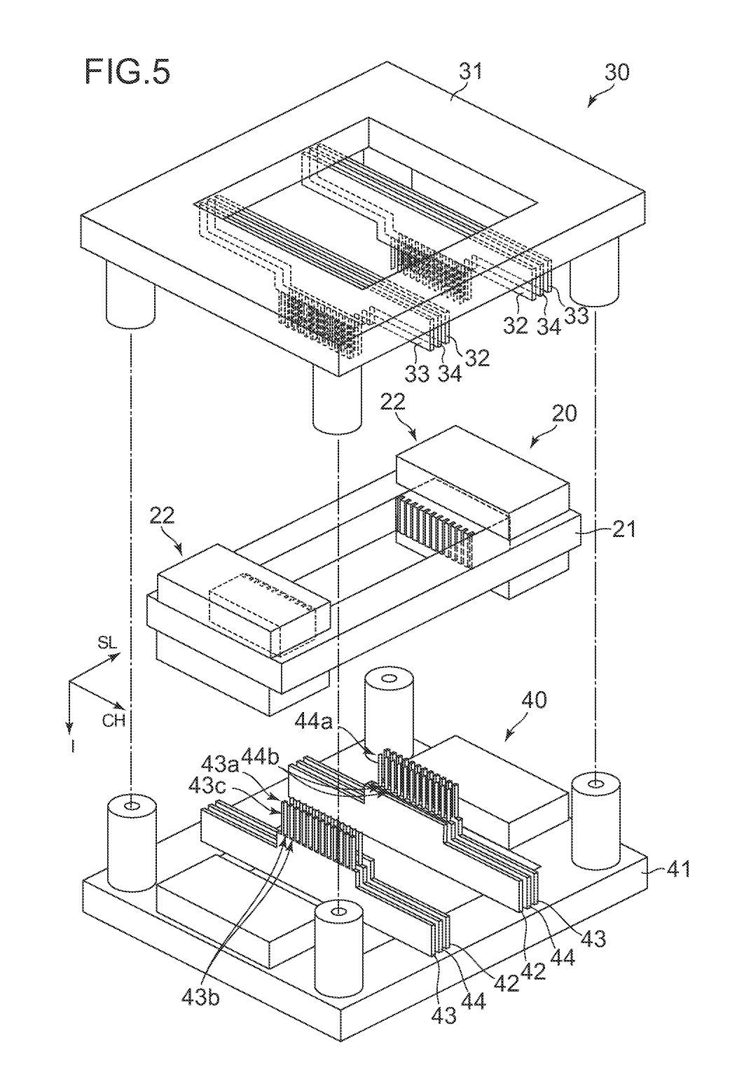

FIG. 5 is a diagram showing a typical structure of the manufacturing jig 10 for the collimator module.

The manufacturing jig 10 for the collimator module is comprised mainly of a fixing jig 20, an upper alignment jig 30, and a lower alignment jig 40. The upper alignment jig 30 and lower alignment jig 40 are configured to combine with the fixing jig 20 by clamping the latter in the up-down direction. These jigs are machined and formed primarily from materials such as steel, stainless steel, and spring steel. Incidentally, the upper alignment jig 30 and lower alignment jig 40 are examples of jigs.

The fixing jig 20 has a frame base 21 and two fixing parts 22. The frame base 21 is a frame-like assembly in which two column-like members extending substantially in parallel in the CH direction have their ends coupled to those of two other column-like members extending substantially also in parallel in the CH direction. One fixing part 22 is located at one end in the SL direction of the frame base 21 and the other fixing part 22 is positioned and the other end of the frame base 21. The two fixing parts 22 are configured to support and fix removably the paired end blocks 2 so that the multiple slots 2a are positioned opposite to one another with a predetermined distance therebetween in the SL direction. The fixing jig 20, with its fixing parts 22 attached to the end blocks 2, is configured to permit access to the upper and lower ends of the slots 2a. Also, the fixing jig 20, with the collimator plates 3 inserted into the slots 2a of the end blocks 2, is configured to permit access to the upper edges 3b and lower edges 3c of the collimator plates 3.

The lower alignment jig 40 is comprised mainly of a lower base 41, two lower receiving ends 42, two lower reference parts 43, and two lower pressing parts 44. Incidentally, the lower reference parts 43 and lower pressing parts 44 are examples of a pair of second comb-like members.

The lower base 41 is an approximately rectangular solid that is wide in the CH and SL directions. In the middle of the lower base 41 is an opening for access purposes.

The lower receiving ends 42 are coupled with and fixed to the lower base 41. The lower receiving ends 42 are configured to receive and support the lower edges 3c of the multiple collimator plates 3 inserted into the slots 2a of the end blocks 2. The two lower receiving ends 42 are positioned symmetrically to each other in the SL direction about the center of the lower base 41.

The lower reference parts 43 are coupled with and fixed to the lower base 41. The lower reference parts 43 are each an approximately rectangular solid with its longitudinal, short, and thickness directions being the CH, I, and SL directions, respectively. Multiple notched grooves 43b are formed in the upper edges 43a of the lower reference parts 43 so that the lower edges 3c of the multiple collimator plates 3 inserted into the slots 2a of the end blocks 2 may be inserted into the grooves 43b. That is, the upper edges 43a of the lower reference parts 43 have a comb-like shape covering the lower edges 3c of the collimator plates 3 in their thickness direction, i.e., in the CH direction. One side of the inner walls of each notched groove 43b in the CH direction (e.g., +CH direction side wall) forms a reference plane 43c machined with high precision and aligned with a particular relative position of the manufacturing jig 10. When the plate faces 3a of the collimator plates 3 come into contact with this reference plane 43c, the collimator plates 3 are aligned accurately.

The lower pressing parts 44 are each an approximately rectangular solid with its longitudinal, short, and thickness directions being the CH, I, and SL directions, respectively. As with the lower reference parts 43, multiple notched grooves 44b are formed in the upper edges 44a of the lower pressing parts 44 so that the lower edges 3c of the multiple collimators 3 inserted into the slots 2a of the end blocks 2 may be inserted into the grooves 44b. That is, the upper edges 44a of the lower pressing parts 44 have a comb-like shape covering the lower edges 3c of the collimator plates 3 in their thickness direction, i.e., in the CH direction. It should be noted that at least the portions making up the notched grooves 44b of the lower pressing parts 44 are formed with a material having spring characteristics such as spring steel. The lower pressing parts 44 are arranged to be close to the lower reference parts 43 in the SL direction and are supported in slidable fashion in the CH direction. The sliding lower pressing parts 44 allow the notched grooves 43b and 44b of the lower reference parts 43 and lower pressing parts 44 to be aligned approximately with one another thereby opening the upper side of the notched grooves (“open” position) or to be staggered with one another thereby closing the upper side of the notched grooves (“closed” position), the “open” position and the “closed” position being switched from one to the other by the sliding feature.

The upper alignment jig 30 and the lower alignment jig 40 are configured in substantially symmetrical fashion to each other in the up-down direction. The upper alignment jig 30 is comprised mainly of an upper base 31, two upper receiving ends 32, two upper reference parts 33, and two upper pressing parts 34. Incidentally, the upper reference parts 33 and upper pressing parts 34 are examples of a pair of first comb-like members.

The upper base 31 is an approximately rectangular solid that is wide in the CH and SL directions. In the middle of the upper base 31 is an opening for access purposes.

The upper receiving ends 32 are coupled with and fixed to the upper base 31. The upper receiving ends 32 are configured to receive and support the upper edges 3b of the multiple collimator plates 3 so that the collimator plates 3, after being inserted into the slots 2a of the end blocks 2 but yet to be fixed thereto by adhesive, will not fall off when the manufacturing jig 10 is positioned upside down. The two upper receiving ends 32 are positioned symmetrically to each other in the SL direction about the center of the upper base 31.

The upper reference parts 33 are coupled with and fixed to the upper base 31. The upper reference parts 33 are each an approximately rectangular solid with its longitudinal, short, and thickness directions being the CH, I, and SL directions, respectively. Multiple notched grooves 33b are formed in the lower edges 33a of the upper reference parts 33 so that the upper edges 3b of the multiple collimator plates 3 inserted into the slots 2a of the end blocks 2 may be inserted into the grooves 33b. That is, the lower edges 33a of the upper reference parts 33 have a comb-like shape covering the upper edges 3b of the collimator plates 3 in their thickness direction, i.e., in the CH direction. One side of the inner walls of each notched groove 33b in the CH direction (e.g., +CH direction side wall) forms a reference plane 33c machined with high precision and aligned with a particular relative position of the manufacturing jig 10. When the plate faces 3a of the collimator plates 3 come into contact with this reference plane 33c, the collimator plates 3 are aligned accurately.

The upper pressing parts 34 are each an approximately rectangular solid with its longitudinal, short, and thickness directions being the CH, I, and SL directions, respectively. As with the upper reference parts 33, multiple notched grooves 34b are formed in comb-like fashion in the lower edges 34a of the upper pressing parts 34 so that the upper edges 3b of the multiple collimators 3 inserted into the slots 2a of the end blocks 2 may be inserted into the grooves 34b. That is, the lower edges 34a of the upper pressing parts 34 have a comb-like shape covering the upper edges 3b of the collimator plates 3 in their thickness direction, i.e., in the CH direction. It should be noted that at least the portions making up the notched grooves 34b of the upper pressing parts 34 are formed with a material having spring characteristics such as spring steel. The upper pressing parts 34 are arranged to be close to the upper reference parts 33 in the SL direction and are supported in slidable fashion in the CH direction. The sliding upper pressing parts 34 allow the notched grooves 34b of the upper reference parts 33 and upper pressing parts 34 to be aligned approximately with one another thereby opening the lower side of the notched grooves (“open” position) or to be staggered with one another thereby closing the lower side of the notched grooves (“closed” position), the “open” position and the “closed” position being switched from one to the other by the sliding feature.

In this example, one upper pressing part 34 is located close to one upper reference part 33. Alternatively, one upper pressing part 34 may be positioned between two upper reference parts 33 in a manner close thereto. The same applies to the lower reference parts 34 and lower pressing parts 44 as well.

Explained below is the method for manufacturing the collimator module using the manufacturing jig 10.

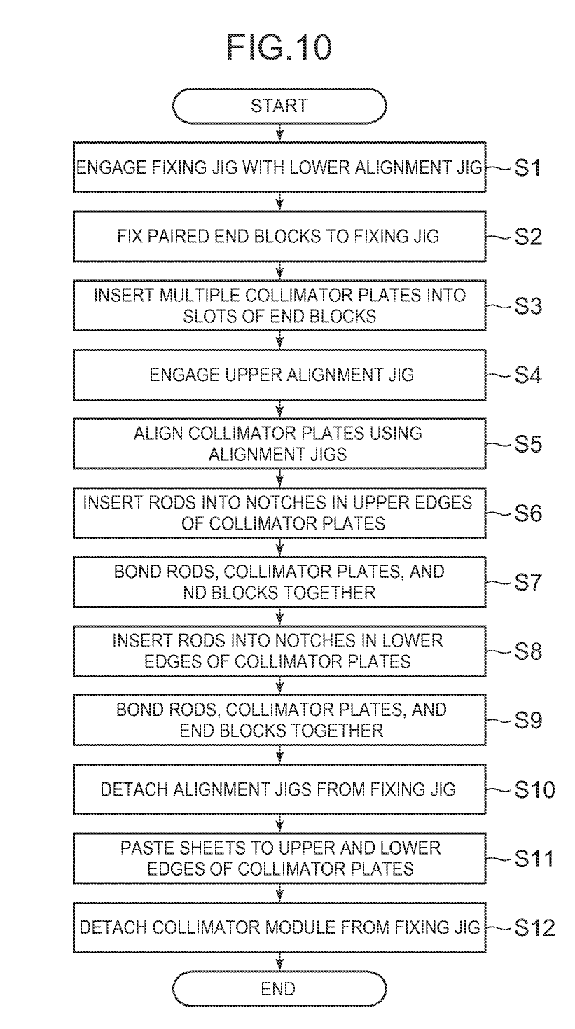

FIG. 10 is a flowchart outlining the method of manufacturing the collimator module by use of the manufacturing jig.

In step S1, the fixing jig 20 and lower alignment jig 40 are prepared in a manner engaged with each other.

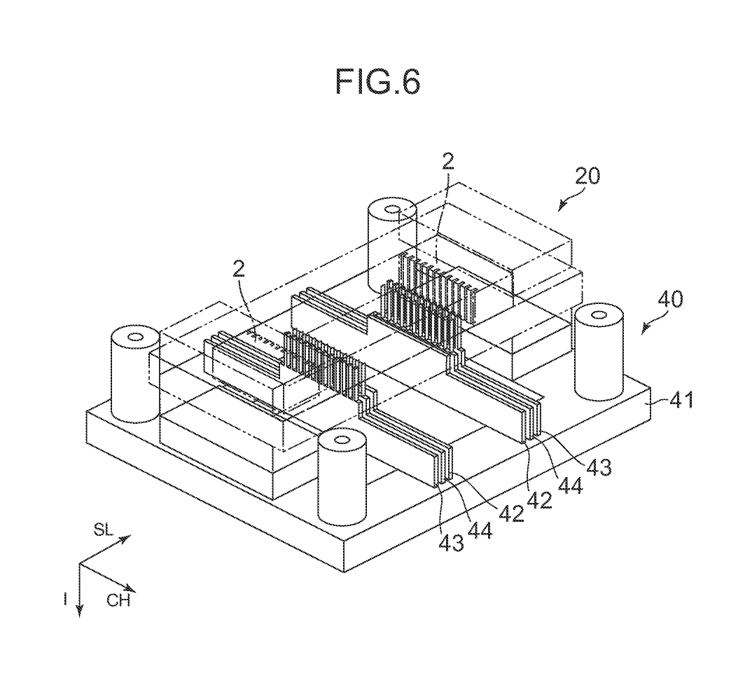

In step S2, the paired end blocks 2 are fixed to the fixing parts 22 of the fixing jig 20, as shown in FIG. 6.

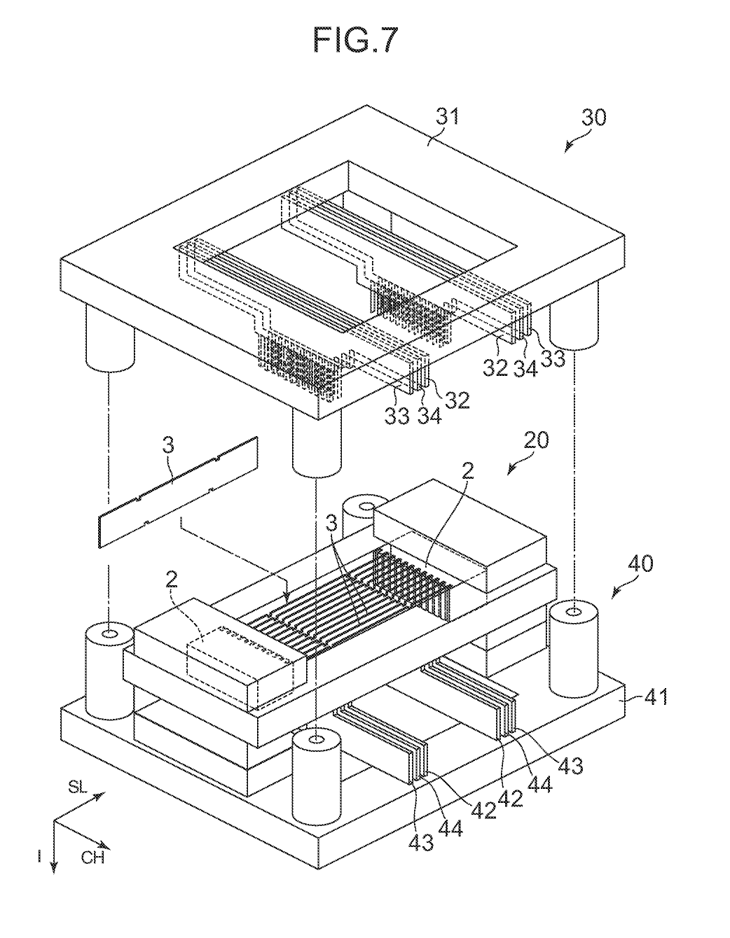

In step S3, the multiple collimator plates 3 are inserted into the slots 2a of the end blocks 2, as shown in FIG. 7. That is, the lower pressing parts 44 of the lower alignment jig 40 are set to the “open” position. Then the collimator plates 3 are inserted in such a manner that each collimator plate 3 is inserted into one pair of opposite slots 2a in the paired end blocks 2. The lower edges 3b of the multiple collimator plates 3 are inserted into the notched grooves 44b of the lower reference parts 43 and lower pressing parts 44, the lower edges 3b being received and supported by the lower receiving ends 42. In this manner, the multiple collimators 3 are temporarily arranged a predetermined distance apart in the CH direction.

In step S4, the upper alignment jig 30 is engaged with the fixing jig 20, as shown in FIG. 7. That is, the upper pressing parts 34 of the upper alignment jig 30 are set to the “open” position. The upper alignment jig 30 is then engaged with the fixing jig 20 from above. This causes the upper edges 3b of the multiple collimator plates 3 to be inserted into the notched grooves 33b and 43b of the upper reference parts 33 and upper pressing parts 34.

In step S5, the collimator plates 3 are aligned using the upper alignment jig 30 and lower alignment jig 40. That is, the upper pressing parts 34 and lower pressing parts 44 are slid into the “closed” position. The plate faces 3a of the collimator plates 3 are then pressed in the CH direction so that they come into contact with the reference plane 43c of the upper reference parts 33 and lower reference parts 43. This allows the multiple collimator plates 3 to be aligned accurately in the CH direction.

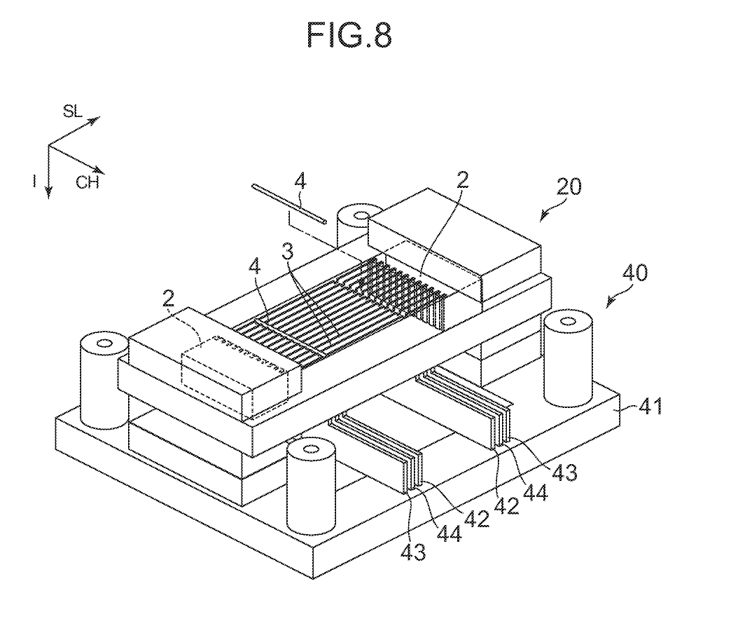

In step S6, the upper fixing rods 4 are inserted into the notches 3n in the upper edges 3b of the multiple collimator plates 3, as shown in FIG. 8. In FIG. 8, the upper alignment jig 30 is not shown for purpose of simplification.

In step S7, the upper fixing rods 4, collimator plates 3, and end blocks 2 are bonded together. That is, the two upper fixing rods 4 are bonded by adhesive to the multiple collimator plates 3. Also, the collimator plates 3 are bonded by adhesive to the paired end blocks 2. The adhesive to be used may be one that cures in a relatively short time, such as one of light cure adhesives, ultraviolet cure adhesives, or two-liquid mixture adhesives. Using this type of adhesive shortens the time required for bonding and thereby improves productivity.

In step S8, the manufacturing jig 10 is positioned upside down. The lower fixing rods 5 are then inserted into the notches 3n in the lower edges 3c of the multiple collimator plates 3.

In step S9, the lower fixing rods 5, collimator plates 3, and end blocks 2 are bonded together. That is, the two lower fixing rods 5 are bonded by adhesive to the multiple collimator plates 3. Also, the collimator plates 3 are bonded by adhesive to the paired end blocks 2. This allows the paired end blocks 3 and the multiple collimator plates 3 are bonded together in an aligned state. The multiple collimator plates 3 are fixed by the upper fixing rods 4 and lower fixing rods 5 approximately in the middle in the SL direction. Thus when the upper alignment jig 30 and lower alignment jig 40 are detached from the fixing jig 20, the midsection of the collimator plates 3 in the SL direction is resistant to deflection (deformation). The aligned state is maintained substantially throughout the entire collimator plates 3.

In step S10, the alignment jigs are detached from the fixing jig 20. That is, the upper pressing parts 34 and lower pressing parts 44 are slid back to the “open” position. The upper alignment jig 30 and lower alignment jig 40 are then detached from the fixing jig 20.

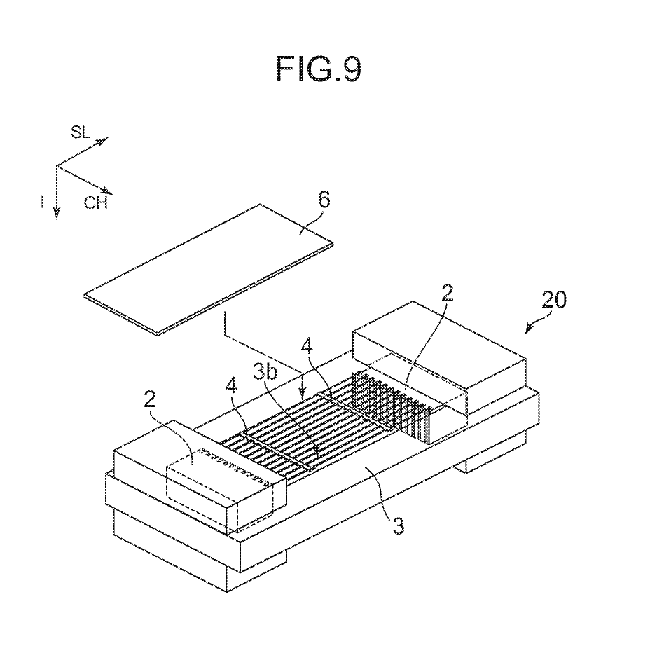

In step S11, the fixing sheets are pasted to the upper and lower edges of the collimator plates 3, as shown in FIG. 9. That is, the single continuous upper fixing sheet 6 is positioned in a manner covering the upper edges 3b of the multiple collimator plates 3 and the upper portions of the slots 2a in the paired end blocks 2, the fixing sheet 6 being pasted thereto by adhesive. Likewise, the single continuous lower fixing sheet 7 is positioned in a manner covering the lower edges 3c of the collimator plates 3 and the lower portions of the slots 2a of the paired end blocks 2, the fixing sheet 7 being pasted thereto by adhesive. This step completes one collimator module 1. Because the continuous upper and lower fixing sheets 6 and 7 are pasted in a manner covering the entire upper and lower portions of the collimator plates 3 and slots 2a, the stiffness of the module is boosted significantly.

In step S12, the completed collimator module 1 is detached from the fixing jig 20.

According to the above-described embodiment, with the multiple collimator plates 3 aligned a predetermined distance apart in the CH direction, the upper fixing rods 4 and lower fixing rods 5 extending in the CH direction from the collimator plate 3 at one end to the collimator plate 3 at the other end are bonded by adhesive to the upper edges 3b and lower edges 3c of the collimator plates 3, whereby the collimator module 1 is obtained. This makes it possible to maintain the aligned state of the collimator plates 3 without recourse to special steps or parts, thereby implementing easily the collimator module 1 with high alignment precision and high stiffness.

Also according to the above-described embodiment, the upper fixing rods 4 and lower fixing rods 5 are bonded by adhesive so that until the alignment jigs 30 and 40 are detached from the multiple collimator plates 3, the aligned state of the plates 3 can be maintained. Thus the upper fixing sheet 6 and lower fixing sheet 7 can be pasted after the alignment jigs 30 and 40 are removed and put out of the way. As a result, the single continuous upper fixing sheet 6 and the single continuous lower fixing sheet 7 may be used to cover the multiple collimator plates 3 and multiple slots 2a as a whole, which improves the stiffness of the collimator module 1 significantly.

Compared with the ordinary method of aligning the multiple collimator plates 3 before bonding them together using other parts, the method of manufacturing the collimator module of the exemplary embodiment is supplemented simply with the additional step of fixing the upper fixing rods 4 and lower fixing rods 5 by adhesive to the collimator plates 3. The manufacturing method described herein is thus very easy and simple to practice. Since there is no need to divide each of the upper fixing sheet 6 and lower fixing sheet 7 and paste them in pieces, the increase in the number of steps and the rise in costs are negligible.

It should be understood that the disclosure is not limited to the above-described embodiment and that various modifications, variations, and alternatives may be made so far as they are within the spirit and scope of the invention.

For example, in the above-described embodiment, the notches 3n are formed in the collimator plates 3 so that the upper fixing rods 4 and lower fixing rods 5 are fitted into and bonded to the notches 3. Alternatively, the notches 3n may be omitted. Instead, the upper fixing rods 4 and lower fixing rods 5 may be placed as they are onto the upper edges 3b and lower edges 3c of the collimator plates 3 and bonded thereto, with the upper fixing sheet 6 and lower fixing sheet 7 laid over the assembly and fixed thereto by adhesive. In this case, the notches 3n may be formed on the surfaces of the upper fixing sheet 6 and lower fixing sheet 7, so that the upper fixing rods 4 and lower fixing rods 5 may be fitted into these notches 3n.

As another example, there are multiple combinations of the notches 3n in the upper edges 3b of the collimator plates 3 and the upper fixing rods 4, as well as multiple combinations of the notches 3n in the lower edges 3c of the collimator plates 3 and the lower fixing rods 5 in the above-described embodiment. Alternatively, at least one of the two sets of combinations may be replaced with a single combination of the parts involved.

As another example, the upper fixing sheet 6 and lower fixing sheet 7 are pasted in the above-described embodiment. Alternatively, instead of pasting the upper fixing sheet 6 and lower fixing sheet 7, there may be provided more notches 3n in the upper edges 3b and lower edges 3c of the collimator plates 3 and more upper fixing rods 4 and lower fixing rods 5. The numerous upper fixing rods 4 and lower fixing rods 5 may then be used to fix the multiple collimator plates 3 and thereby improve the stiffness of the module.

As another example, the upper fixing rods 4 and lower fixing rods 5 are each a rod-like member extending in the direction in which the multiple collimator plates 3 are arranged, i.e., in the CH direction, in the above-described embodiment. Alternatively, the fixing rods may each be a rod-like member extending obliquely relative to the CH direction.

As another example, the multiple grooves in which to insert the upper edges 3b of the multiple collimator plates 3 are formed on the upper fixing sheet 6, and the multiple grooves in which to insert the lower edges 3c of the collimator plates 3 are formed on the lower fixing sheet 7 in the above-described embodiment. Alternatively, at least one of the upper fixing sheet 6 and lower fixing sheet 7 may be a flat fixing sheet with no grooves formed thereon.

As another example, the multiple slots 2a are formed in the I direction on each of the two opposed faces of the paired end blocks 2 in the above-described embodiment. Alternatively, the paired end blocks 2 may be devoid of slots.

As another example, the above-described embodiment is an X-ray CT scanner. Alternatively, the systems and methods described herein may also be applied to ordinary X-ray equipment for imaging the chest region, mammography equipment for imaging the breasts, angiography equipment for acquiring angiographic images of blood vessels, and other radiation imaging devices such as a PET-CT scanner that combines an X-ray CT scanner and PET (positron emission tomography) and a SPECT-CT scanner that combines an X-ray CT scanner and SPECT (single photon emission computed tomography).

Thus the scope of the invention should be determined by the appended claims and their legal equivalents, rather than by the examples given.

1. A collimator module manufacturing method comprising:
aligning a plurality of collimator plates arranged a predetermined distance apart in one direction, each of the collimator plates being substantially a rectangular solid;
bonding a first bar-like member to upper edges of the collimator plates, the first bar-like member being radiolucent and extending from a first collimator plate at a first end to a second collimator plate at a second end in the direction of the collimator plate arrangement, and
bonding a second bar-like member to the lower edges of the collimator plates, the second bar-like member being radiolucent and extending from the first collimator plate to the second collimator plate.

2. The collimator module manufacturing method according to claim 1, wherein notches are formed in each of the upper and lower edges of the collimator plates, and
wherein the first and the second bar-like members are each fitted into the notches.

3. The collimator module manufacturing method according to claim 1, further comprising:
before aligning the plurality of collimator plates, positioning a pair of end blocks a predetermined distance apart in a direction perpendicular to the direction of the collimator plate arrangement;
arranging the collimator plates between the paired end blocks; and
bonding the collimator plates to the paired end blocks.

4. The collimator module manufacturing method according to claim 3, wherein a plurality of slots extending in a direction of irradiation are formed on each of two opposite faces of the paired end blocks, and
wherein aligning the plurality of collimator plates comprises inserting each of the collimator plates into an associated pair of the slots.

5. The collimator module manufacturing method according to claim 1, further comprising:
after bonding the first and second bar-like members, pasting a radiolucent first single sheet onto those upper edges of the collimator plates to which the first bar-like member has been bonded, the first single sheet being pasted such that the first bar-like member covers the upper edges; and
pasting a radiolucent second single sheet onto those lower edges of the collimator plates to which the second bar-like member has been bonded, the second single sheet being pasted such that the second bar-like member covers the lower edges.

6. The collimator module manufacturing method according to claim 5, where the aligning the plurality of collimator plates comprises aligning the collimator plates by use of a jig, and
wherein, after bonding the first and second bar-like members and before pasting the first and second bar-like members, the method further comprises detaching from the jig the collimator plates to which the first and the second bar-like members have been bonded.

7. The collimator module manufacturing method according to claim 1, wherein the jig includes at least a pair of first comb-like members in which to insert the upper edges of the collimator plates and at least a pair of second comb-like member in which to insert the lower edges of the collimator plates, and
wherein aligning the plurality of collimator plates comprises, with one comb-like member of a first pair of the comb-like members and one comb-like member of a second pair of the comb-like members fixed, sliding the other comb-like member of the first pair and the other comb-like member of the second pair in the direction of the collimator block arrangement to clamp the collimator plates for alignment.

8. The collimator module manufacturing method according to claim 7, wherein bonding the first and second bar-like members comprises bonding the first and the second bar-like members close to the first pair of comb-like members and the second pair of comb-like members.

9. A collimator module comprising:
a plurality of collimator plates arranged a predetermined distance apart in one direction, each of the collimator plates being substantially a rectangular solid;
at least one first bar-like member bonded to upper edges of the collimator plates, the first bar-like member being radiolucent and extending from a first collimator plate at a first end to a second collimator plate at the second end in the direction of the collimator plate arrangement;
at least one second bar-like member bonded to lower edges of the collimator plates, the second bar-like member being radiolucent and extending from the first collimator plate to the second collimator plate, and
a pair of end blocks clamping the collimator plates in a direction perpendicular to the direction of the collimator plate arrangement.

10. The collimator module according to claim 9, wherein the first and the second bar-like members extend in the direction of the collimator plate arrangement.

11. The collimator module according to claim 9, wherein notches are formed in each of the upper and the lower edges of the collimator plates, and
wherein the first and the second bar-like members are each fitted into the notches.

12. The collimator module according to claim 9, wherein a plurality of slots extending in the direction of irradiation are formed on each of the two opposite faces of the paired end blocks, and
wherein each of the collimator plates is inserted into an associated pair of the slots.

13. The collimator module according to claim 9, further comprising:
a radiolucent first single sheet pasted onto those upper edges of the collimator plates to which the first bar-like member has been bonded, the first single sheet being pasted such that the first single sheet covers the upper edges, and
a radiolucent second single sheet pasted onto those lower edges of the collimator plates to which the second bar-like member has been bonded, the second single sheet being pasted such that the second single sheet covers the lower edges.

14. The collimator module according to claim 13, wherein the first and the second single sheets are pasted such that the first and second single sheets cover the slots.

15. The collimator module according to claim 13, wherein a plurality of grooves are formed on a face of the first single sheet which covers the upper edges of the collimator plates, the upper edges being inserted into the grooves, and
wherein a plurality of grooves are formed on a face of the second single sheet which covers the lower edges of the collimator plates, the lower edges being inserted into the grooves.

16. The collimator module according to claim 13, wherein the first and the second single sheets are each made from a carbon plastic material.

17. The collimator module according to claim 9, wherein the first and the second bar-like members are each made from a carbon material.

18. A radiation detection device comprising a plurality of collimator modules arranged in one of a predetermined circular direction and a predetermined linear direction, each of the collimator modules being a collimator module according to claim 11, and
a plurality of detector modules arranged in the direction of the collimator module arrangement on a radiation emitting side of the collimator modules.

19. A radiation imaging device comprising a radiation source and the radiation detection device according to claim 18, wherein the radiation source and the radiation detection device are configured to image an imaging object.

20. The radiation imaging device according to claim 19, wherein the radiation imaging device is configured to acquire a tomographic image of the imaging object by causing the radiation source and the radiation detection device to rotate around the imaging object and to emit radiation thereto.
